(19) United States
(12) Patent Application Publication
(10) Pub. No.: US 2026/0154332 A1
(43) Pub. Date: Jun. 4, 2026

(54) MULTI-MODAL IMAGE EXTRACTION AND RETRIEVAL USING RETRIEVAL AUGMENTED GENERATION

(71) Applicant: Genpact USA, Inc., New York, NY (US)

(72) Inventors: Ayushman Gupta, Bengaluru (IN); Sukanya Bag, Kolkata (IN); Rajat Kaushik, Patiala (IN); Chirag Jain, Bangalore (IN); Sreekanth Menon, Bangalore (IN)

(21) Appl. No.: 18/967,124

(22) Filed: Dec. 3, 2024

(51) Int. Cl. G06F 16/58; G06T 11/60; G06V 10/25; H04L 9/32

(52) U.S. Cl. CPC G06F 16/5866; G06T 11/60; G06V 10/25; H04L 9/3239

(57) ABSTRACT

A system for retrieval of images using Retrieval Augmented Generation (RAG) including a tagging engine and a vector engine. The tagging engine is configured to receive an electronic document having an image, determine a location of the image in the electronic document, generate an image localization tag (ILT) based on the location of the image, and replace the image in the electronic document with the ILT to produce a modified electronic document. The vector engine is configured to vectorize and store the modified electronic document in a vector database for subsequent search and retrieval using RAG.

### TECHNICAL FIELD

The following disclosure is directed to systems and methods for extracting and retrieving both images and text sourced from electronic documents and, more specifically, to the extraction and retrieval of images along with text using Retrieval Augmented Generation (RAG).

### BACKGROUND

Traditional mechanisms for image retrieval often rely heavily on Optical Character Recognition (OCR) integrated with Language Learning Models (LLMs) to interpret and contextualize images within documents. However, this integration poses significant challenges, including bottlenecks in processing speed and accuracy issues stemming from the OCR component. These challenges become even more pronounced when dealing with images that are not OCR-compatible like flowcharts, diagrams, scientific devices, or manuals leading to a loss of information and discontinuity between text and visual elements which is crucial to address in responses generated by LLMs.

### SUMMARY

At least one aspect of the present disclosure is directed to a system for retrieval of images using Retrieval Augmented Generation (RAG). The system includes a tagging engine configured to receive an electronic document having an image, determine a location of the image in the electronic document, generate an image localization tag (ILT) based on the location of the image, and replace the image in the electronic document with the ILT to produce a modified electronic document, and a vector engine configured to vectorize and store the modified electronic document in a vector database for subsequent search and retrieval using RAG.

In some embodiments, in determining the location of the image in the electronic document, the tagging engine is configured to determine bounding box coordinates of the image. In some embodiments, the tagging engine is configured to replace the image in the electronic document with the ILT by inserting the ILT within the bounding box coordinates of the image. In some embodiments, the ILT comprises an image identifier, a hash value, and an image file extension. In some embodiments, the tagging engine is configured to use a Secure Hash Algorithm 1 (SHA-1) function to generate the hash value. In some embodiments, the hash value is a portion of a full SHA-1 value. In some embodiments, the system includes an extraction engine configured to extract the image from the electronic document and store the extracted image in an image database. In some embodiments, the extracted image is stored with a filename that includes at least the hash value and the image file extension of the ILT.

In some embodiments, the system includes a retrieval engine configured to receive a query, retrieve data from the vector database having a contextual relevance to the query, wherein the retrieved data includes relevant text and the ILT, provide at least one prompt to a large language model (LLM) based on the query, wherein the at least one prompt instructs the LLM to address the query based on the retrieved data, receive a textual response output from the LLM including the ILT, and retrieve the image associated with the ILT from the image database. In some embodiments, the retrieval engine is configured to insert the retrieved image in the textual response output received from the LLM. In some embodiments, the retrieval engine is configured to insert the retrieved image in the textual response output with a positional alignment that is consistent with a positional alignment of the image in the electronic document.

Another aspect of the present disclosure is directed to a method for retrieving images using Retrieval Augmented Generation (RAG). The method includes receiving an electronic document having an image, determining a location of the image in the electronic document, generating an image localization tag (ILT) based on the location of the image, replacing the image in the electronic document with the ILT to produce a modified electronic document, generating a vectorized version of the modified electronic document, and storing the vectorized version of the modified in a vector database for subsequent search and retrieval using RAG.

In some embodiments, determining the location of the image in the electronic document comprises determining bounding box coordinates of the image. In some embodiments, replacing the image in the electronic document with the ILT comprises inserting the ILT within the bounding box coordinates of the image. In some embodiments, the ILT comprises an image identifier, a hash value, and an image file extension. In some embodiments, the method includes generating the hash value using a Secure Hash Algorithm 1 (SHA-1) function. In some embodiments, the hash value is a portion of a full SHA-1 value. In some embodiments, the method includes extracting the image from the electronic document and storing the extracted image in an image database. In some embodiments, the extracted image is stored with a filename that includes at least the hash value and the image file extension of the ILT.

In some embodiments, the method includes receiving a query, retrieving data from the vector database having a contextual relevance to the query, wherein the retrieved data includes relevant text and the ILT, providing at least one prompt to a large language model (LLM) based on the query, wherein the at least one prompt instructs the LLM to address the query based on the retrieved data, receiving a textual response output from the LLM including the ILT, and retrieving the image associated with the ILT from the image database. In some embodiments, the method includes inserting the retrieved image in the textual response output received from the LLM. In some embodiments, inserting the retrieved image in the textual response output comprises inserting the retrieved image in the textual response output with a positional alignment that is consistent with a positional alignment of the image in the electronic document.

Further aspects and advantages of the invention will become apparent from the following drawings, detailed description, and claims, all of which illustrate the principles of the invention, by way of example only.

### BRIEF DESCRIPTION OF THE DRAWINGS

A more complete appreciation of the invention and many attendant advantages thereof will be readily obtained as the same becomes better understood by reference to the following detailed description when considered in connection with the accompanying drawings. In the drawings, like reference characters generally refer to the same parts throughout the different views. Further, the drawings are not necessarily to scale, with emphasis instead generally being placed upon illustrating the principles of the invention.

FIG. 1 illustrates a block diagram of a multi-modal image processing system in accordance with aspects described herein;

FIG. 2 illustrates a flow diagram of a method for operating the multi-modal image processing system of FIG. 1 in accordance with aspects described herein;

FIG. 3 illustrates a flow diagram of a method for operating the multi-modal image processing system of FIG. 1 in accordance with aspects described herein;

FIG. 4 illustrates an example of a response generated by the multi-modal image processing system of FIG. 1 in accordance with aspects described herein;

FIG. 5 illustrates an operational workflow of the multi-modal image processing system of FIG. 1 in accordance with aspects described herein; and

FIG. 6 illustrates an example computing device.

### DETAILED DESCRIPTION

Disclosed herein are exemplary embodiments of systems and methods for extracting and retrieving images sourced from electronic documents and, more specifically, to the extraction and retrieval of images for Retrieval Augmented Generation (RAG).

RAG is an advanced natural language processing technique that combines the strengths of information retrieval and generative models to enhance the quality and accuracy of generated content. Typically, a retrieval component first searches for relevant documents or data from a large text dataset (or corpus), providing the generative model with factual and contextually rich information. The generative model then uses this retrieved information to produce more informed and coherent responses or content. This hybrid method improves the ability of language models to generate accurate and contextually appropriate text, particularly in complex or knowledge-intensive tasks.

RAG systems are often capable of providing consistent and accurate text-based results when used with large text datasets. However, such systems often struggle to process and retrieve images with the same levels of consistency and accuracy. Traditional mechanisms for image retrieval often rely heavily on Optical Character Recognition (OCR) integrated with Language Learning Models (LLMs) to interpret and contextualize images within documents. OCR is used to extract textual content in images followed by an LLM that is utilized to create an image caption from the raw OCR extracted text. The caption and the image metadata is then paired and loaded into a vector store for RAG retrievals. However, this integration poses significant challenges, including bottlenecks in processing speed and accuracy issues stemming from the OCR component. These challenges become even more pronounced when dealing with images that are not OCR-compatible like flowcharts, diagrams, scientific devices, or manuals leading to a loss of information and discontinuity between text and visual elements which is crucial to address in responses generated by LLMs. OCR-based solutions rely on textual information that is included in (or part of) the original image. As such, images having no textual information may not be retrievable. For example, non-text images, like scientific figures or flowcharts, pose a challenge, as OCR's inability to find text leads to irrelevant image captions. In addition, retrieval depends on the semantic similarity between user queries and the OCR-based image captions. However, such OCR-based captions are typically a brief summary of the extracted image text; not the image itself. As such, there is a high chance that the OCR-based image captions do not align semantically with the user's query, even if there are relevant images to be retrieved.

Further, RAG systems utilize an image selection hyperparameter k which determines the number of images that are retrieved for each user query. In many cases, OCR-based solutions struggle to retrieve relevant images for different fixed k values. For high k values, OCR-based solutions often include irrelevant images. Likewise, for low k values, OCR-based solutions often miss or omit the most relevant images. This is because OCR-based solutions extract textual content from images to generate image captions. In many cases, the image reference (or caption) pinpoints to explaining a specific part, or in some cases, a larger part of the image. For example, an image snapshot which describes how to change a user password in an application may contain text apart from just the word “password.” The OCR extraction cannot distinguish or weigh the importance of the word “password” in the image with respect to a query asking how to change the user password (e.g., “How to reset the password in XYZ application?”). The OCR-based solution will simply extract each and every word it can find from the image snapshot and create a summarized caption out of it. The caption may not capture the actual importance of the word “password” due to noise created by other words found in the snapshot (e.g., “log in,” “sign in,” “username,” “verify email,” etc.). Similarly, a graph visualization of tax rates in different countries of the world may include text of different countries and different tax rates (e.g., numeric rates). If the heading of the graph is not embedded in the image but present as text below the image in the electronic document, the OCR extraction performed on the image will only extract country names and tax values. As such, the caption generated for the image will likely be unaligned with the user query, because the OCR-based solution is unable to identify that the image is a graph of tax rates in different countries.

In many cases, OCR-based solutions provide images separately from textual content. As such, the text-to-image spatial alignment and flow of information in the response is disrupted, hindering the user's ability to understand the content of the response. In addition, OCR-based solutions are often cost-intensive due to the number of LLM calls needed to generate image captions. For example, a corpus with 10,000 documents having 100 images each corresponds to approximately 1 million OCR and LLM calls.

Accordingly, improved systems and methods for extracting and retrieving images sourced from electronic documents for RAG are provided herein. In at least one embodiment, a tagging engine is configured to receive an electronic document having an image and determine a location of the image in the electronic document. In some embodiments, the tagging engine generates an image localization tag (ILT) based on the location of the image and replaces the image in the electronic document with the ILT to produce a modified electronic document. In some embodiments, a vector engine is configured to vectorize and store the modified electronic document in a vector database for subsequent retrieval using RAG.

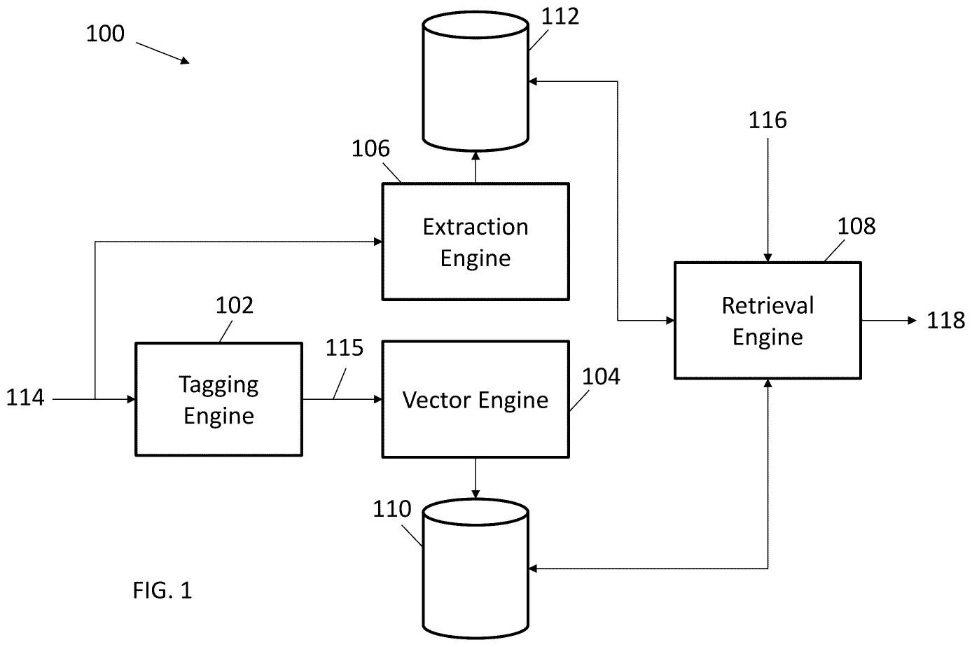

FIG. 1 is a block diagram of a multi-modal image processing system 100 in accordance with aspects described herein. As shown, the system 100 includes a tagging engine 102, a vector engine 104, an extraction engine 106, and a retrieval engine 108. In some examples, the engines of the system 100 are implemented by one or more application servers. Each application server comprises software components and databases that can be deployed at one or more data centers in one or more geographic locations, for example. The software components can comprise subcomponents that can execute on the same or on a different individual data processing apparatus. In some examples, the system 100 includes (or is configured to access) a vector database 110 and an image database 112. The databases 110, 112 can reside in one or more physical storage systems in one or more geographic locations.

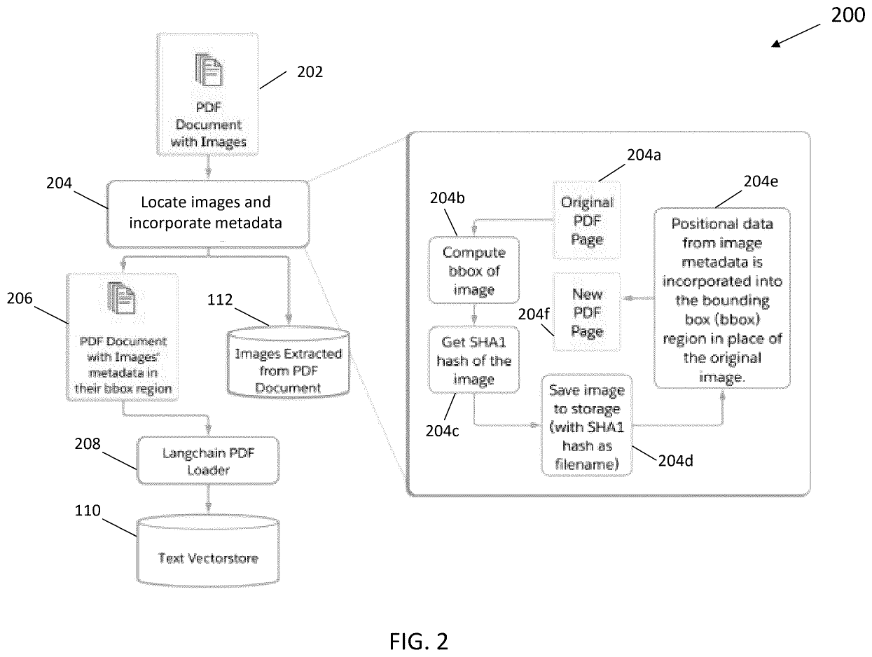

FIG. 2 illustrates a flow diagram of a method 200 for operating the RAG image processing system 100 in accordance with aspects described herein. In some examples, the method 200 corresponds to the operation of loading an electronic document into the vector database 110.

At step 202, the system 100 receives an electronic document 114 (e.g., a PDF document, a Word document, etc.) having at least one image. In some examples, the electronic document 114 is provided to the tagging engine 102. In some examples, the electronic document 114 is provided to the tagging engine 102 and the extraction engine 106 simultaneously. The electronic document 114 may be an application guide, a user manual, programming instructions, a literature review, a research articles, a patent publication, or any other desired type of document.

At step 204, the system 100 (i) determines a location of the image in the electronic document 114 and (ii) incorporates image metadata in the location of the image. In some examples, the location of the image corresponds to a bounding box of the image. Sub-steps 204a-204f describe the process of incorporating image metadata. At sub-step 204a, the tagging engine 102 selects the page of the electronic document 114 having the image. In the event the electronic document 114 is a single-page document, the tagging engine 102 may select the entire electronic document 114. At sub-step 204b, the tagging engine 102 performs a bounding box computation to pinpoint the location and size of the image (e.g., the bounding box coordinates). In some examples, the bounding box computation is performed using one or more libraries (e.g., PyMuPDF). The bounding box allows the tagging engine 102 to create a connection between the textual and visual content of the document 114. The bounding box (or bounding box coordinates) is used by the system 100 to maintain the spatial and semantic alignment of the image with the associated (or proximate) text.

At sub-step 204c, the tagging engine 102 generates an image localization tag (ILT) for the image. In some examples, the ILT includes image identifier, a hash value, and an image file extension. For example, the ILT may be represented as: <image: filename(23523473.png)>. In some examples, the image identifier is a tag or label (e.g., “image” or “image:”) that is used by the system 100 to identify the ILT. The image identifier enables the system 100 to quickly retrieve the image in response to a RAG query. In some examples, the hash value is a Secure Hash Algorithm 1 (SHA-1) value. The tagging engine 102 may be configured to include (or use) a hashing function to generate the hash value. For example, the hashing function may be used to generate the hash value (or ID) based on the image. In some examples, the hashing function is an SHA-1 hashing function. In some examples, the tagging engine 102 is configured to generate a hash value that corresponds to a portion of a full SHA-1 value (e.g., 4 digits, 8 digits, 12 digits, etc.). For example, the hash value included in the ILT may be a truncated version of a SHA-1 hash value. In some examples, the truncated hash value allows the ILT to be inserted within tables (or other document features) where the full SHA-1 value would cause the ILT to overlap with document content or another ILT. In some examples, the tagging engine 102 uses the following equation to truncate the hash value: [H mod 10**n], where H is the decimal (base 10) representation of the full SHA-1 hash value and n is the number of digits the hash value is being shrunk down to (e.g., 8 digits).

While the ILT format described above includes an image object identifier, a modified image SHA1 Hash ID, and a file extension, it should be appreciated that the format of the ILT may be highly flexible and modifiable according to one's use case requirements and complexity of the document. For example, if the electronic document 114 meets a desired document standard (e.g., includes proper sections and subsections, provides an explanation of purpose and scope, includes image information in text below corresponding images, etc.), then incorporating only the image filename in the ILT pattern (e.g., “<image: filename(<039478.png>)”) may be sufficient to retrieve the images, as the image information present in text for the image will usually be in high proximity to the ILTs. On the contrary, if the electronic document 114 does not meet the desired document standard (e.g., the images do not have figure information, the document is messy or not organized, the document text does not refer to the image, etc.), additional metadata may be incorporated in the ILT pattern, such as a short and concise description of the image (e.g., “<image: filename(<394873.png>) description: ‘creating virtual environment with python 3.10>’”). In such examples, the incorporation of additional metadata in the ILT pattern improves the accuracy and quality of image retrieval.

At sub-step 204d, the extraction engine 104 extracts the image from the electronic document 114 and saves the image in the image database 112. In some examples, the extraction engine 104 is configured to save the image using the hash value from the ILT (i.e., the hash value computed in sub-step 204c). In some examples, the filename of the image is the hash value (e.g., 23523473.png). In some examples, the tagging engine 102 is configured to provide the hash value to the extraction engine 104.

At sub-step 204e, the tagging engine 102 embeds the ILT within the electronic document 114 in place of the extracted image. The ILT is embedded to inject the image's information in the respective position of the image in the electronic document 114. This specific placement of the ILT enhances future retrieval of the image by (i) maintaining text-image continuity dictating the original document's structure/content and (ii) establishing an acquired semantic correlation between text and images based on spatial proximity of images alongside text. In some examples, the precise location for embedding the ILT is specified by the bounding box determined in sub-step 204b. The ILT embedding is performed with attention to the original document layout, preserving the region specified by the bounding box to avoid any misalignment issues. The ILT serves as a contextual placeholder or a visual context marker within the document, encapsulating both the spatial coordinates and the semantic essence of the image. This ensures that each image is not only anchored in its original location but is also inherently connected to the relevant textual information. At sub-step 204f, the tagging engine 102 produces a modified document page containing a rich interplay of text with the ILT, mirroring the original structure of the electronic document page while enhancing it for advanced text retrieval capabilities. In some examples, a copy of the original (unmodified) electronic document page is stored (e.g., in database 110 or 112) such that it can be referenced, cited, and/or displayed as an information source in RAG-based responses.

It should be appreciated that step 204 (i.e., sub-steps 204a-204f) is repeated for each page of the electronic document 114 that includes an image. Likewise, step 204 may be repeated for each individual image on a page of the electronic document 114. For example, when a document page includes two or more images, the corresponding modified document page produced by the tagging engine 102 includes two or more ILTs.

At step 206, the tagging engine 102 produces a modified version of the electronic document 115. In some examples, the modified electronic document 115 is produced by combining the modified document pages with the unmodified (i.e., imageless) document pages. For example, if a 10-page document includes images on pages 3 and 7, then the modified document 115 is produced by replacing original pages 3 and 7 with the modified pages 3 and 7 produced by the tagging engine 102.

At step 208, the modified version of the electronic document 115 is incorporated into the vector database 110. In some examples, this involves creating a vector representation (e.g., embeddings) of the electronic document 115 using embeddings techniques and/or transformer models (e.g., text embedding ada-002/text embedding 3 large models from OpenAI). In some examples, the modified version of the electronic document 115 is vectorized using one or more libraires (e.g., Langchain's PDF Loader). In some examples, an indexing service (e.g., Microsoft Azure AI Search) is used to ingest the vector embeddings into the vector database 110. The vectors may be stored in a way that they can be quickly accessed in the vector database 110. The result is an indexed database where the contents of the electronic document 115 is easily searchable. In some examples, the indexed vector database 110 enables quick and efficient retrieval of documents based on queries asked by the user. In some examples, the electronic document 115 is broken into smaller parts or chunks via a chunking process (e.g., using “chunk_size” and “chunk_overlap” hyperparameters of Langchain's Text Splitter). The chunking process may be performed to abide by the context window of an LLM. In some examples, splitting the electronic document 115 into smaller chunks increases the speed at which the electronic document 115 is converted vector embeddings and ingested into the vector database 110. It should be appreciated that the modified version of the electronic document 115 is integrated in the vector database 110 while maintaining its layout and meaning. In some examples, vectorization of the modified version of the electronic document 115 facilitates efficient multi-modal retrieval. As described below, the information stored in the vector database 110 is retrieved using RAG in response to user queries.

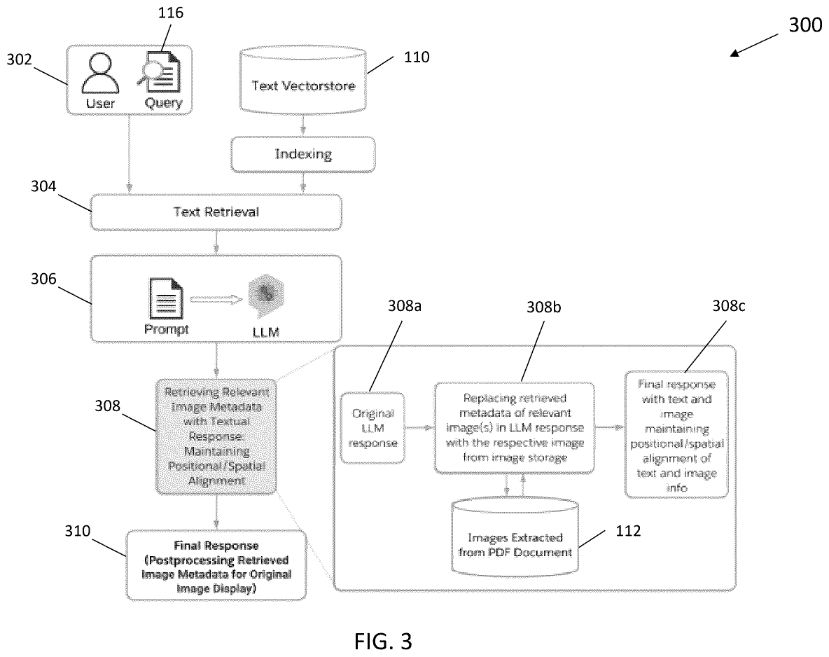

FIG. 3 illustrates a flow diagram of a method 300 for operating the multi-modal image processing system 100 in accordance with aspects described herein. In some examples, the method 300 corresponds to the operation of retrieving information responsive to a user query. In some examples, the retrieved information includes a relevant image and a textual response.

At step 302, the retrieval engine 108 receives a query 116 from a user. In some examples, the query 116 corresponds to a request for information or a question to be answered. For example, the query 116 may be “Show me examples of how specialized attention heads in a Transformer recover protein structure and function.”

At step 304, the retrieval engine 108 retrieves text from the vector database 110 that is relevant to query 116. In some examples, the retrieval engine 108 is configured to vectorize at least a portion of the query 116. The vectorized query 116 may be compared to the vectorized information in vector database 110 in order to retrieve relevant text. In some examples, the retrieval engine 108 includes (or uses) a Maximum Marginal Relevance (MMR) retriever. The MMR retriever may select chunks (or sections) of text based on their cosine similarity to query 116. In some examples, the MMR retriever is configured to minimize redundancy across the selected text chunks. In some examples, the text (or information) stored in vector database 110 is indexed as a vector index, which increases the speed and accuracy of retrieval.

At step 306, the retrieval engine 108 provides a prompt to an LLM based on query 116. In some examples, the prompt is generated by the retrieval engine 108 based on a prompt template that instructs the LLM to address query 116 using the text retrieved in step 304. For example, the prompt may include query 116 (or a portion of query 116) and the retrieved text. In some examples, the prompt directs the LLM to a location where the retrieved text is stored.

At step 308, the retrieval engine 108 (i) receives a textual response from the LLM based on the prompt and (ii) produces a final response that incorporates images into the textual response. Sub-steps 308a-308c describe the process of incorporating images into the textual response. At sub-step 308a, the retrieval engine 108 receives the textual response produced by the LLM. In some examples, the textual response from the LLM includes one or more ILTs. For example, the LLM may include ILTs in the textual response that were included in the text retrieved from the vector database 110. At sub-step 308b, the retrieval engine 108 replaces the ILTs in the textual response with the corresponding images stored in the image database 112. In some examples, the retrieval engine 108 uses a portion of the ILT to retrieve the corresponding image from the image database. For example, the images may be stored in the image database 112 with a filename that corresponds to the hash value and the file extension of the ILT. As such, the retrieval engine 108 may extract the hash value and the file extension from the ILT to generate the filename for retrieval from the image database 112. At sub-step 308c, the retrieval engine 108 combines the content of the textual response with the retrieved images in a manner that maintains the original positional/spatial alignment of the text and image information (e.g., the alignment of the electronic document 114). In some examples, the retrieval engine 108 uses the bounding box information computed for each image to integrate the image with text while maintaining the original alignment.

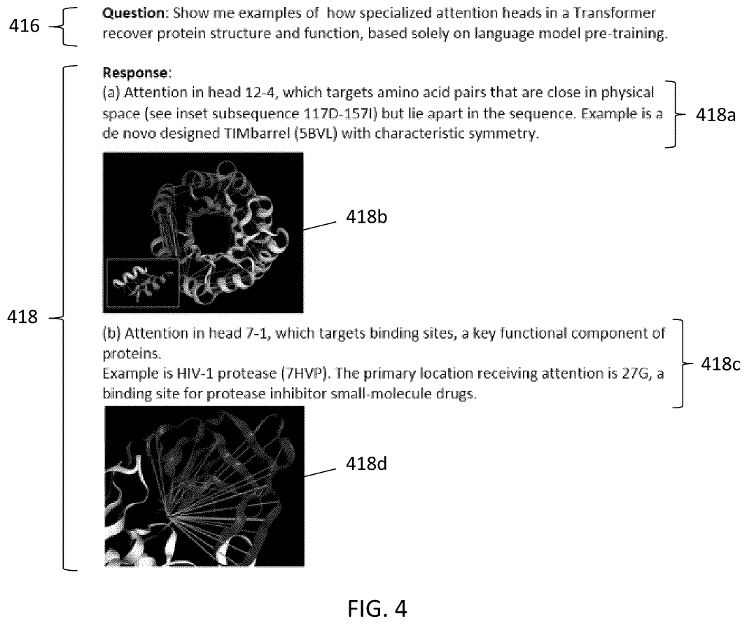

At step 310, retrieval engine 108 provides the final response 118 to query 116. In some examples, the final response 118 is presented to the user via a user interface. FIG. 4 illustrates an example final response 418 generated by system 100 in response to a query 416. As shown, the query 416 recites “Show me examples of how specialized attention heads in a Transformer recover protein structure and function, based solely on language model pre-training.” The corresponding response 418 includes a first text section 418a, a first image 418b, a second text section 418c, and a second image 418d that are arranged and positioned based on the original source document(s) (e.g., electronic document 114).

In some examples, the document retrieval process includes a chain-of-thought (CoT) prompt tuning technique. The CoT prompt tuning technique uses targeted prompts that guide the LLM to consider ILTs during its response generation. This ensures that the LLM's output maintains fidelity to the document's layout and the images'contextual relevance. When the LLM retrieves content containing ILTs, the targeted prompts enable the original structure and meaning of the document to be preserved. Following the LLM's response, a post-processing step is performed that involves identifying ILTs in the in the LLM response, extracting associated image data, and then substituting the ILTs with the actual images. The result is a comprehensive response that accurately reflects the placement and relevance of images as per the original document structure.

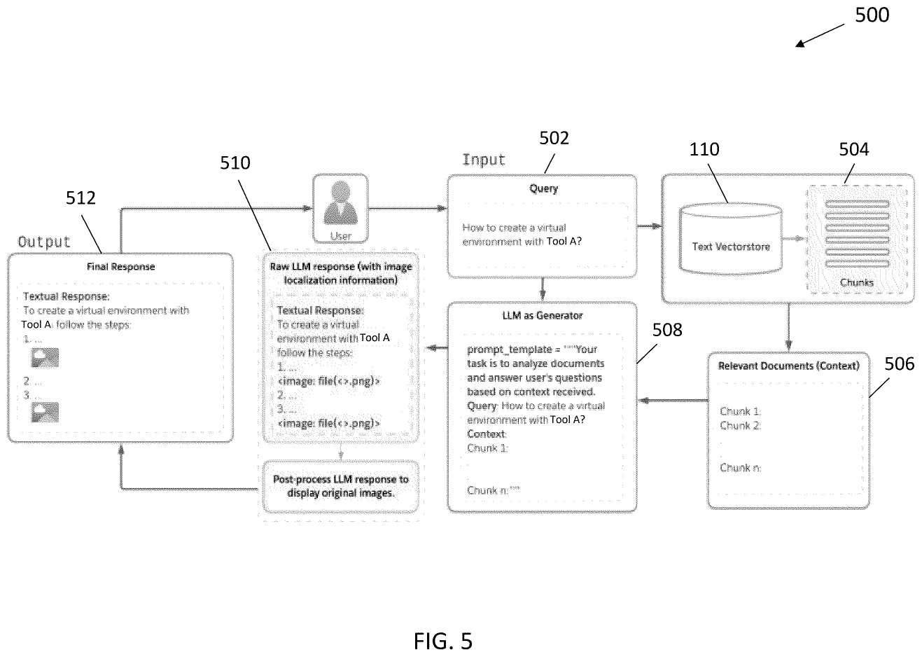

FIG. 5 illustrates an example workflow 500 corresponding to the method 300 of FIG. 3. The workflow 500 represents an example of the CoT prompt tuning technique described above. As shown, query 502 is provided by a user to system 100. The query 502 is received by the retrieval engine 108 of the system 100 (step 302 of the method 300). In some examples, query 502 is entered by the user via a user interface. In some examples, the query 502 is a question, such as “How to create a virtual environment with Tool A?” The retrieval engine 108 uses query 502 to retrieve relevant text from the vector database 110 (step 304 of the method 300). In some examples, the retrieval engine 108 is configured to retrieve a plurality of text chunks 504 from the vector database 110. In some examples, the plurality of text chunks 504 have a contextual relevance to query 502. As described above, an MMR retriever may be used to retrieve the plurality of text chunks 504. In some examples, at least a portion of the query 502 is vectorized by the retrieval engine 108 in order to retrieve the plurality of text chunks 504. In some examples, a list of relevant documents 506 is compiled from the plurality of text chunks 504. In some examples, the list 506 corresponds to an ordered list of the plurality of text chunks 504, where the chunks are ordered (or ranked) based on relevance. For example, the most contextually relevant text chunks may be listed higher than the less relevant text chunks. In some examples, the list 506 corresponds to a portion of the plurality of text chunks 504. For example, the list 506 may include the n most relevant text chunks from the plurality of text chunks 504. In some examples, n is a predetermined number.

The retrieval engine 108 provides a prompt 508 to an LLM (step 306 of the method 300). In some examples, the prompt 508 is constructed using a prompt template. In some examples, the prompt template includes an instruction section, a query section, and a context section. In some examples, the instruction section of the prompt template includes one or more instructions that guide or direct the LLM to address the query 502 based on the list of relevant documents 506 (or the plurality of text chunks 504). For example, as shown in FIG. 5, the instruction section of the prompt template may recite “Your task is to the analyze the documents and answer user's questions based on context received.” In some examples, the same instruction section is used for all user queries. In some examples, the instruction section of the prompt template varies based on the type of user query (e.g., question, topic, list, etc.). In some examples, the query section of the prompt template includes the query 502 verbatim. In some examples, the query section of the prompt template includes a portion of the query 502. For example, a multi-pronged query 502 may be broken into portions that are included in separate prompt templates. In some examples, the query section of the prompt template includes a modified version of the query 502. The query 502 may be packaged or arranged into a predetermined format (e.g., a question, a command, a request, etc.). For example, the original query 502 of “How to create a virtual environment with Tool A?” may be restructured into a command format, such as “Provide instructions for creating a virtual environment with Tool A.” In some examples, the context section of the prompt template includes the list of relevant documents 506 (or the plurality of text chunks 504). The context section of the prompt template may include the actual text of the relevant text chunks 506 or a link to the relevant text chunks 506 (e.g., a link to where the text chunks are stored).

The retrieval engine 108 receives a textual response 510 produced by the LLM in response to the prompt 508 (sub-step 308a of the method 300). As shown in FIG. 5, the textual response 510 includes text along with associated ILTs. As described above, the retrieval engine 108 is configured to retrieve the images corresponding to each ILT from the image database 112 (sub-step 308b of the method 300). The retrieval engine 108 combines the content of the textual response 510 with the retrieved images in a manner that maintains the original positional/spatial alignment of the text and image information (sub-step 308c of the method 300). Final response 512 is the combination of the textual response 510 with the retrieved images. As shown, the positional/spatial alignment of the text and image information is maintained in the final response 512. For example, the first image is positioned at the location of the first ILT between text elements 1 and 2. Likewise, the second image is positioned at the location of the second ILT following text element 3.

As described above, OCR-based solutions often struggle to retrieve the correct number of relevant images for different fixed k values (where k is the top relevant images). This is because such OCR-based solutions perform separate text and image retrievals. In some cases, OCR may fail to capture the actual meaning of the image with respect to text in the source document. The embodiments described herein overcome these deficiencies of OCR-based solutions. For example, the system 100 establishes a text-image relevance proximity by embedding image metadata in the location of the image (e.g., using ILTs) so that both image and textual information are embedded as text embeddings. The system 100 passes user queries into the retrieval engine 108 for document and embedding searches, which not only pulls out the relevant chunks of text, but also the relevant images as ILTs found in proximity to the text. As such, the system 100 has no dependency on static k values which may differ query-to-query. The system 100 replaces the ILTs with the images from the image database 112 to produce a response that includes textual information along with images aligned with the text as dictated by the original source document.

As such, improved systems and methods for extracting and retrieving images sourced from electronic documents for RAG are provided herein. The system 100 described herein overcomes many of the deficiencies associated with traditional OCR-based image retrieval solutions. For example, the costs associated with OCR captioning calls to LLMs can be eliminated, improving the cost efficiency of image retrieval using the system 100. The system 100 can retrieve images of any kind - ranging from a vast array of natural objects, biomedical images, flowcharts, logic diagrams, scientific instruments, software/application snapshots, and the like. Likewise, the system 100 can retrieve images that are not OCR compatible.

The ILT technique described herein demonstrates an improvement over existing systems, such the OCR-based technique. In a test using research papers, manuals, programming documentations, and guides/surveys, the ILT technique consistently achieved higher accuracy. Specifically, the ILT technique achieved accuracy scores of 91% for research papers, 94% for programming guides, and 95% for manuals and guides/surveys. In comparison, the OCR-based technique scored in a range from 60% to 70%. As such, the ILT approach offers superior performance in accurately localizing and helping in extraction of information from documents across various domains, making it a more effective choice compared to OCR-based approaches.

### Hardware and Software Implementations

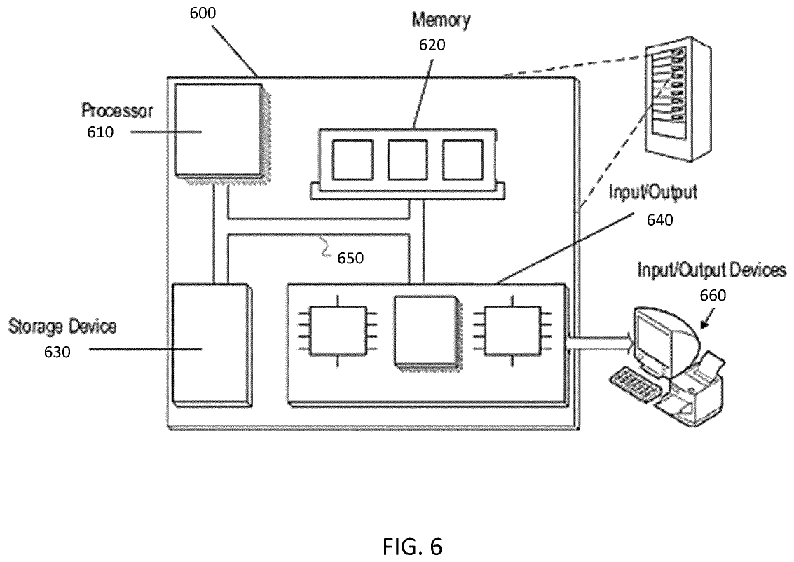

FIG. 6 is a block diagram of an example computer system 600 that may be used in implementing the systems and methods described herein. General-purpose computers, network appliances, mobile devices, or other electronic systems may also include at least portions of the system 600. The system 600 includes a processor 610, a memory 620, a storage device 630, and an input/output device 640. Each of the components 610, 620, 630, and 640 may be interconnected, for example, using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in memory 620 or on storage device 630.

The memory 620 stores information within the system 600. In some implementations, the memory 620 is a non-transitory computer-readable medium. In some implementations, the memory 620 is a volatile memory unit. In some implementations, the memory 620 is a non-volatile memory unit. In some examples, some or all of the data described above can be stored on a personal computing device, in data storage hosted on one or more centralized computing devices, or via cloud-based storage. In some examples, some data is stored in one location and others in another. In some examples, quantum computing can be used. In some examples, functional programming languages can be used. In some examples, electrical memory, such as flash-based memory, can be used.

The storage device 630 is capable of providing mass storage for the system 600. In some implementations, the storage device 630 is a non-transitory computer-readable medium. In various different implementations, the storage device 630 may include, for example, a hard disk device, an optical disk device, a solid-date drive, a flash drive, or some other large capacity storage device. For example, the storage device may store long-term data (e.g., database data, file system data, etc.). The input/output device 640 provides input/output operations for the system 600. In some implementations, the input/output device 640 may include one or more of a network interface device, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer, and display devices 660. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 630 may be implemented in a distributed way over a network, such as a server farm or a set of widely distributed servers or may be implemented in a single computing device.

Although an example processing system has been described in FIG. 6, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, for example, general or special purpose microprocessors or both, or any other kind of central processing unit. Generally, a central processing unit will receive instructions and data from a read-only memory or a random-access memory or both. A computer includes a central processing unit for performing or executing instructions and one or more memory devices for storing instructions and data. Generally, a computer will also include or be operatively coupled to receive data from or transfer data to, or both, one or more mass storage devices for storing data, e.g., magnetic, magnetic optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media, and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are remote from each other and typically interact through a communication network. The relationship of client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated from the described processes. Accordingly, other implementations are within the scope of the following claims.

The phraseology and terminology used here is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to An only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure and are intended to be within the spirit and scope of the invention. Accordingly, the foregoing description and drawings are by way of example only.

What is claimed is:

1. A system for retrieval of images using Retrieval Augmented Generation (RAG), comprising:
a tagging engine configured to:
receive an electronic document having an image;
determine a location of the image in the electronic document;
generate an image localization tag (ILT) based on the location of the image; and
replace the image in the electronic document with the ILT to produce a modified electronic document; and
a vector engine configured to vectorize and store the modified electronic document in a vector database for subsequent search and retrieval using RAG.

2. The system of claim 1, wherein in determining the location of the image in the electronic document, the tagging engine is configured to determine bounding box coordinates of the image.

3. The system of claim 1, wherein the tagging engine is configured to replace the image in the electronic document with the ILT by inserting the ILT within the bounding box coordinates of the image.

4. The system of claim 1, wherein the ILT comprises an image identifier, a hash value, and an image file extension.

5. The system of claim 4, wherein the tagging engine is configured to use a Secure Hash Algorithm 1 (SHA-1) function to generate the hash value.

6. The system of claim 5, wherein the hash value is a portion of a full SHA-1 value.

7. The system of claim 4, further comprising:
an extraction engine configured to extract the image from the electronic document and store the extracted image in an image database.

8. The system of claim 7, wherein the extracted image is stored with a filename that includes at least the hash value and the image file extension of the ILT.

9. The system of claim 7, further comprising:
a retrieval engine configured to:
receive a query;
retrieve data from the vector database having a contextual relevance to the query,
wherein the retrieved data includes relevant text and the ILT;
provide at least one prompt to a large language model (LLM) based on the query,
wherein the at least one prompt instructs the LLM to address the query based on the retrieved data;
receive a textual response output from the LLM including the ILT; and
retrieve the image associated with the ILT from the image database.

10. The system of claim 9, wherein the retrieval engine is configured to insert the retrieved image in the textual response output received from the LLM.

11. The system of claim 10, wherein the retrieval engine is configured to insert the retrieved image in the textual response output with a positional alignment that is consistent with a positional alignment of the image in the electronic document.

12. A method for retrieving images using Retrieval Augmented Generation (RAG), comprising:
receiving an electronic document having an image;
determining a location of the image in the electronic document;
generating an image localization tag (ILT) based on the location of the image;
replacing the image in the electronic document with the ILT to produce a modified electronic document;
generating a vectorized version of the modified electronic document; and
storing the vectorized version of the modified in a vector database for subsequent search and retrieval using RAG.

13. The method of claim 12, wherein determining the location of the image in the electronic document comprises determining bounding box coordinates of the image.

14. The method of claim 13, wherein replacing the image in the electronic document with the ILT comprises inserting the ILT within the bounding box coordinates of the image.

15. The method of claim 12, wherein the ILT comprises an image identifier, a hash value, and an image file extension.

16. The method of claim 15, further comprising:
generating the hash value using a Secure Hash Algorithm 1 (SHA-1) function.

17. The method of claim 16, wherein the hash value is a portion of a full SHA-1 value.

18. The method of claim 15, further comprising:
extracting the image from the electronic document; and
storing the extracted image in an image database.

19. The method of claim 18, wherein the extracted image is stored with a filename that includes at least the hash value and the image file extension of the ILT.

20. The method of claim 18, further comprising:
receiving a query;
retrieving data from the vector database having a contextual relevance to the query, wherein the retrieved data includes relevant text and the ILT;
providing at least one prompt to a large language model (LLM) based on the query, wherein the at least one prompt instructs the LLM to address the query based on the retrieved data;
receiving a textual response output from the LLM including the ILT; and
retrieving the image associated with the ILT from the image database.

21. The method of claim 20, further comprising:
inserting the retrieved image in the textual response output received from the LLM.

22. The method of claim 21, wherein inserting the retrieved image in the textual response output comprises inserting the retrieved image in the textual response output with a positional alignment that is consistent with a positional alignment of the image in the electronic document.
